(19) United States
(12) Patent Application Publication
(10) Pub. No.: US 2009/0047564 A1
(43) Pub. Date: Feb. 19, 2009

(54) Electrical Power Consuming Installation Using a Fuel Cell and Method of Supplying One Such Installation

(75) Inventor: Frederic Touvard, Revel (FR)

Correspondence Address: AIR LIQUIDE;Intellectual Property, 2700 POST OAK BOULEVARD, SUITE 1800, HOUSTON, TX, 77056, US

(73) Assignee: L'Air Liquide Societe Anonyme Pour L'Etude Et L'Ex ploitation Des Procedes Georges Claude, Paris (FR)

(21) Appl. No.: 12/093,166

(22) PCT Filed: Oct. 17, 2006
(86) PCT No.: PCT/FR2006/051042

§ 371 Date: Oct. 10, 2008

(30) Foreign Application Priority Data
Nov. 10, 2005 (FR) 0553420

(51) Int. Cl. H01M 8/22

(52) U.S. Cl. 429/34; 429/13

(57) ABSTRACT

The invention relates to a functional installation which consumes electrical power and which uses a fuel cell. The inventive installation includes: an electrical power consuming member; a fuel cell which is connected to the consuming member in order to supply same with electrical power, said fuel cell being of the type that uses gas fuel, particularly gaseous hydrogen; and a first reserve of gas fuel which is stored under pressure and which is intended to supply the cell by default. The invention is characterized in that the installation also includes: a second reserve of gas fuel which is stored under pressure and which is intended for the cell; means for selectively distributing fuel to the cell from the first or second reserve, whereby said distribution means can detect a supply fault or an insufficient supply from the first reserve; and means for automatically switching to the second reserve for fuel distribution in the event of an insufficient or faulty supply from the first reserve.

The present invention relates to a functional installation consuming electric power and using a fuel cell, and a method for supplying power to such an installation.

The invention relates more particularly to a functional installation consuming electric power, using a fuel cell and comprising an electric power consuming member, a fuel cell connected to the consuming member to supply same with electric power, the fuel cell being of the type using a gaseous fuel, in particular hydrogen gas, a first reserve of fuel gas stored under pressure for supplying the cell by default.

Some electric power consuming installations are supplied by a fuel cell generating electricity from hydrogen and air. The use of a fuel cell may be preferred to other electric power sources (such as an electricity grid), particularly if the installation is too distant from an electrical grid or for reasons of safety or intolerance to power supply failures.

Such installations concern, for example, telecommunication relays, bank sites, medical laboratories or switchgear, etc.

To generate electricity, a fuel cell must be supplied with fuel, for example hydrogen gas.

Conventionally, in the abovementioned installations, a fuel reserve is provided to supply the cell. However, the known installations are unsatisfactory in terms of the management of the reserve for supplying fuel to the cell. In fact, the known installations may be subject to fuel supply failures (particularly in case of leakage). To solve this problem, one known solution consists in oversizing the fuel reserve intended to supply the cell. This solution is unsatisfactory because it requires immobilizing a large volume of fuel (in general several racks of pressurized cylinders). Moreover, this solution is sometimes incompatible with the space available for the fuel reserve.

Furthermore, to estimate the remaining life of the cell in the known installations, it is necessary to measure the pressure in the reserve with means that must be compatible with the high pressures measured. These measurement means are generally costly.

It is one object of the present invention to overcome all or part of the drawbacks of the prior art listed above.

For this purpose, the installation according to the invention, which also conforms to the generic definition given in the above introduction, is essentially characterized in that it comprises a second fuel gas reserve for the cell, means for selectively distributing fuel to the cell from the first or the second reserve, the distribution means being capable of detecting a supply fault or an insufficient supply from the first reserve and means for automatically switching the fuel distribution to the second reserve in the event of such an insufficient or faulty supply from the first reserve, and in that the first fuel gas reserve is connected to the cell by means of a first supply line comprising first means for controlling the pressure and/or expanding the gas to a first delivery pressure, the second fuel gas reserve is connected to the cell by means of a second supply line comprising second means for controlling the pressure and/or expanding the gas to a second pressure, which is different from the first pressure.

Furthermore, the invention may comprise one or more of the following features:
the installation comprises means for detecting an insufficient supply of fuel from the first reserve,
the switching member, the fuel cell and the second reserve are placed substantially in the same container or substantially adjacent to one another in a first zone,
the first reserve is relatively distant from the combination comprising the consuming member, the fuel cell and the second reserve,
the installation comprises means for measuring or estimating the quantity of fuel gas consumed in real time by the cell, data processing means accommodating means for measuring or estimating the quantity of fuel consumed in real time by the cell and conformed to calculate the moment of an insufficient fuel threshold in the first reserve, the data processing means being connected to the distribution means to control the switching of the fuel distribution from the first reserve to the second reserve in the event that the fuel threshold is or becomes insufficient in the first reserve,
the data processing means comprise data storage and transmission means suitable for communicating with a system for monitoring a group of installations,
the installation comprises means for determining and/or acquiring the initial quantity of fuel in the first reserve,
the installation comprises flow and/or pressure detecting means at the outlet of the second reserve,
the installation comprises means for measuring the gas pressure in or at the outlet of the second reserve,
the first fuel gas reserve is connected to the cell by means of a first supply line comprising first means for controlling the pressure and/or expanding the gas to a first delivery pressure,
the second fuel gas reserve is connected to the cell by means of a second supply line comprising second means for controlling the pressure and/or expanding the gas to a second pressure,
the fuel cell is supplied by pressure swing,
the first and second supply lines comprise different upstream portions connected respectively to the first and the second reserve and meeting at a common downstream portion connected to the cell, the first delivery pressure being higher than the second delivery pressure, in order to cause on the one hand a supply of the cell by default from the first reserve when the fuel pressure in the first reserve is higher than the first delivery pressure, and on the other, a supply of the cell from the second reserve when the fuel pressure in the first reserve is lower than the first delivery pressure,
the common downstream portion comprises third means for controlling the pressure and/or expanding the gas to a third delivery pressure,
the method comprises a set of switching the fuel distribution from the first reserve to the second reserve when an insufficient fuel threshold is determined in the first reserve.

A further object of the invention is to propose a method for supplying power to such a functional installation.

For this purpose, the supply method relates to a functional installation consuming electric power, using a fuel cell, comprising an electric power consuming member, a fuel cell connected to the consuming member to supply same with electric power, the fuel cell being of the type using a gaseous fuel, in particular hydrogen gas, a first and second reserve of fuel gas suitable for supplying the cell, the method comprising:
a step consisting in supplying the cell by default from the first reserve,
a step of detecting or determining an insufficient or faulty fuel supply from the first reserve,
a step of switching the fuel supply to the second reserve when the fuel supply from the first reserve is liable to be insufficient or is faulty, characterized in that the step for detecting or determining an insufficient or faulty fuel supply from the first reserve consists in exclusively detecting a gas supply from the second reserve by a pressure and/or flow measurement in and/or at the outlet of the second reserve.

According to other features:
the method comprises a step of determining the initial quantity of fuel in the first reserve, a step of measuring or estimating the quantity of fuel consumed in real time by the cell, and a step of determining an insufficient fuel threshold reached in the first reserve according to the initial quantity of fuel and the quantity of fuel consumed in real time,
the step of detecting or determining an insufficient or faulty fuel supply comprises a flow detection at the outlet of the second reserve.

Other features and advantages will appear from a reading of the description below, provided in conjunction with the figures in which:

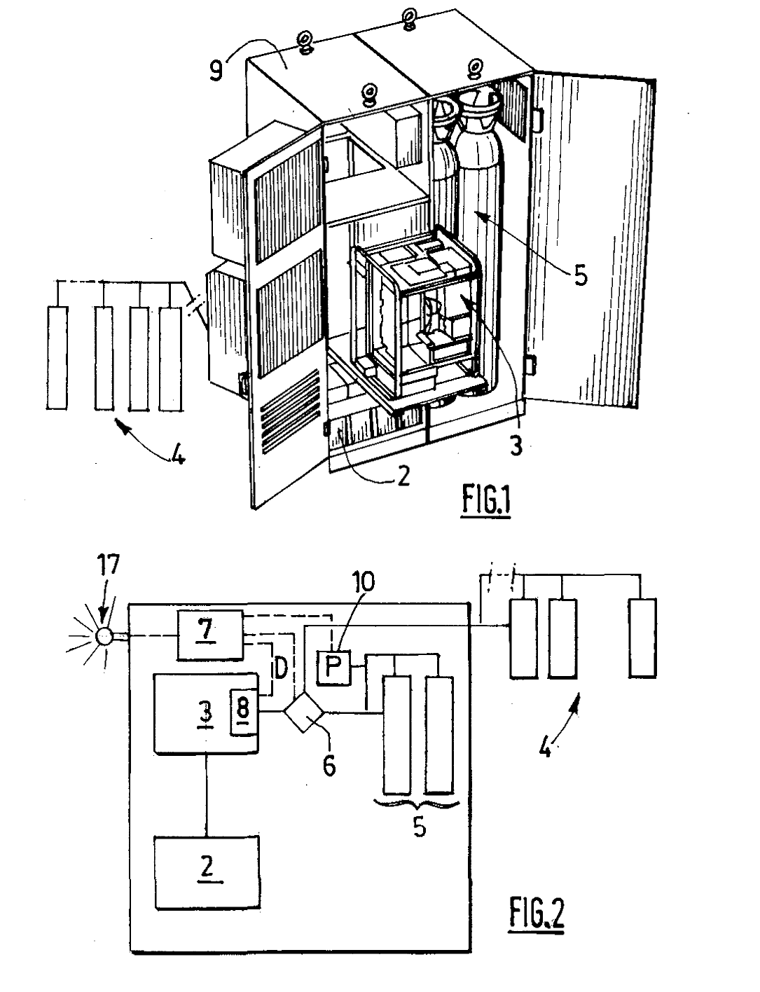

FIG. 1 shows a schematic perspective view of an exemplary embodiment of the installation according to the invention.

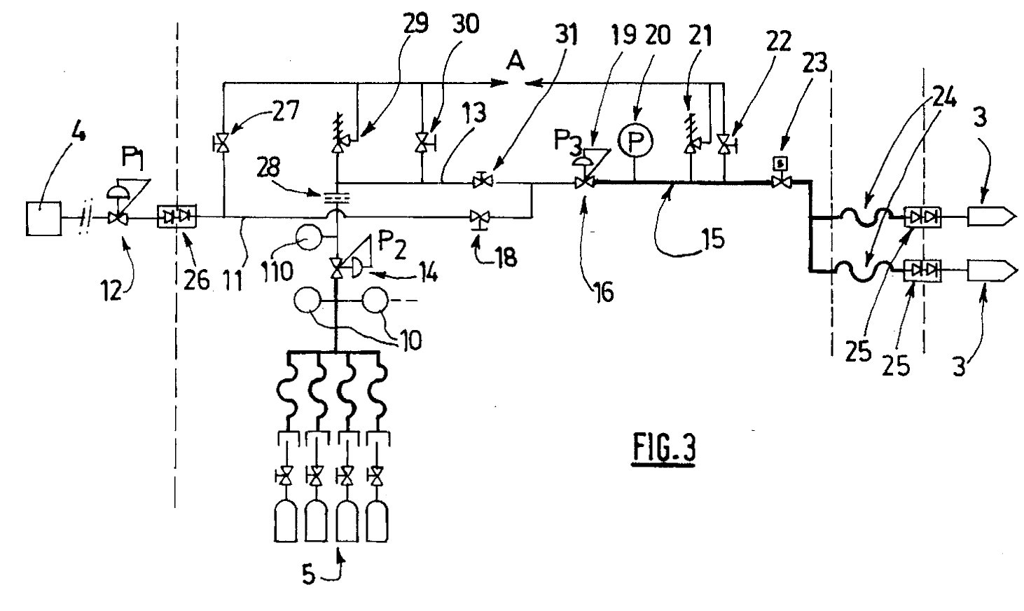

FIG. 2 shows a schematic view illustrating the structure and operation of an installation of the type shown in FIG. 1,

FIG. 3 shows a detail of an installation of the type shown in FIGS. 1 and 2 illustrating an exemplary embodiment of a structure of part of a fuel supply circuit.

FIG. 1 shows a cubicle 9 containing at least one electric power consuming member 2, for example electronic devices forming a relay or a wireless telephone radio communication antenna.

The cubicle contains at least one fuel cell 3 provided to supply electric power to the consuming member 2. The fuel cell 3 conventionally generates electricity from hydrogen gas and air. Such a fuel cell is, for example, a Proton Exchange Membrane (PEM) type cell.

Preferably, the cell 3 is placed adjacent or at least close to the consuming member 2. In this way, the connections between the cell 3 and the member 2 can be simplified and reduced. Furthermore, in this case, in the cold season, the heat generated by the cell 2 can be used to heat the chamber and the cold apparatus.

The cell 3 is normally supplied (by default) by a first reserve 4 of hydrogen gas stored under pressure. For example, the hydrogen is stored in a first reserve 4 at a pressure of at least 10 bar. The first reserve 4 comprises, for example, one or more gas cylinders and preferably at least one rack comprising a plurality of cylinders (shown in FIG. 1).

Advantageously, the first reserve 4 may be placed relatively distant from the cubicle 9 containing the cell 3 and the consuming member 1. For example, at a distance of a few meters or a score of meters or more. By offsetting the first reserve 4 in this way, it is possible to supply cells 2 located in areas unsuitable for accommodating a relatively bulky reserve 4 and also the replacement or maintenance operations on the cylinder racks 4.

According to the invention, the installation also comprises a second hydrogen gas reserve 5 preferably placed close to the cell 3 and advantageously also in the cubicle 9. The second reserve 5 comprises for example at least one cylinder or tank of pressurized hydrogen gas and preferably a plurality of cylinders.

The second reserve 5 constitutes a buffer reserve for ensuring the continuous supply of the cell 3 with hydrogen, in case of failure of the first reserve 4. The second reserve 5 is for example dimensioned to provide sufficient fuel supply for the operations of a pressurized gas maintenance or distribution team (for example 24 to 48 hours). Preferably, the second reserve 5 has a lower capacity than the first reserve (and hence a smaller volume). Preferably, the ratio between the quantity of fuel of the first reserve 4 and the quantity of fuel of the second reserve 5 is between ⅓ and 1/100.

FIG. 2 shows a simplified view of the installation according to the invention. For the sake of brevity, the elements identical to those described above are denoted by the same reference numerals and are not described in detail a second time.

According to the invention, the installation comprises means 6 for selectively distributing fuel to the cell 3 from the first 4 or the second reserve 5. These distribution means 6 are preferably capable of detecting a supply fault or an insufficient supply from the first reserve 4, to automatically switch the fuel distribution to the second reserve 5 when the first reserve 4 is insufficient or faulty.

Such an architecture has many advantages. In fact, rather than using two large-sized reserves, of which one remains immobilized and full over long periods, the second reserve 5 serves to provide a smaller buffer serve optimizing the mobilization of the gas on the installation site.

Preferably, the installation is equipped with means 10 for measuring the gas pressure in or at the outlet of the second reserve 5. For example, a pressure sensor 10 records the gas pressure at the outlet of the second reserve 5. The data is advantageously transmitted to data processing means 7 of the installation. Preferably, these data processing means 7 comprise data storage and transmission means 17 suitable for communicating with a known system for monitoring a group of tanks or installations. For example, an antenna 17 allows wireless communication of the data from the installation to a known system for centralizing and remote-monitoring of a plurality of similar or different installations (not shown), in order to manage the gas supply or for maintenance operations.

Advantageously, the installation according to the invention may comprise means 8 for measuring or estimating the quantity of fuel gas consumed in real time by the cell 3. These measurement or estimation means 8 may be located at the cell 3 itself, for example while monitoring the quantity of electricity delivered in real time by the cell 3 (the electricity generated by the cell being substantially proportional to the quantity of fuel consumed).

The data processing means 7 (comprising a computer or similar) are connected to the measurement or estimation means 8 and receive the data D concerning the quantity of fuel consumed in real time by the cell 3. The data processing means 7 can calculate the moment of an insufficient fuel threshold in the first reserve 4. For example, an insufficient fuel threshold may be calculated by the data processing means 7 from the known initial quantity of fuel in the first reserve 4. This initial quantity can be acquired during the supply of the installation (acquired or filled in automatically by data support means mounted on the cylinders, for example).

The data processing means 7 may also detect a default of the installation, for example a fuel leak after its outlet from the first reserve 4.

In these situations, the data processing means 7 control the switching of the fuel distribution from the first reserve 4 to the second reserve 5.

FIG. 3 more accurately shows an exemplary embodiment of a fuel distribution circuit between the two reserves 4, 5 and at least one cell 3.

For the sake of brevity, identical elements to those described above are denoted by the same reference numerals and are not described in detail a second time.

The first fuel gas reserve 4 is connected to the cell 3 by means of a first supply line 11. The first supply line 11 comprises, from upstream to downstream (that is from the reserve to the cell 3), first means 12 for controlling the pressure and/or expanding the gas. These first means 12 comprise, for example, a relief valve and are conformed to expand the gas to a first delivery pressure P1 (for example about 8 bar). The first line 11 then comprises means 26 forming a non-return valve and a bypass to the atmosphere A controlled by a first purge valve 27. Downstream, the first line 11 comprises a shutoff valve 18, for example manual. Downstream, the first supply line 11 is formed from a downstream portion 15 comprising, from upstream to downstream, a downstream pressure reducer 19, a pressure sensor 20, a safety valve 21 to the atmosphere A, a purge valve 22 which can be connected to the atmosphere A and a safety valve 23. Downstream of the safety valve 23, the downstream portion 15 comprises two parallel lines each provided with a non-return valve 25 and an end for connection to a respective cell 3. In fact, FIG. 3 illustrates the fact that the installation can supply more than one fuel cell 3.

The second fuel gas reserve 5 is connected to the cells 3 by means of a second supply line 13. The second reserve 5 comprises, from upstream to downstream (that is from the reserve to the cells 3), means 10 for measuring the gas pressure at the outlet of the second reserve 5 and second means 14 for controlling the pressure and/or expanding the gas to a second pressure P2. The second means 14 for controlling the pressure and/or expanding the gas comprise for example a pressure reducer of a known type.

These second expansion means 14 are conformed to expand the gas to a second delivery pressure P2 which is lower than the first delivery pressure P1 (for example about 5 bar).

Downstream, the second supply line 13 comprises means 10 for measuring the gas pressure downstream of the pressure reducer, and a calibrated orifice 28 for limiting the gas flow. Downstream of the calibrated orifice 28, the second supply line 13 comprises a safety valve 29 to the atmosphere A, a purge valve 30 to the atmosphere A and a shutoff valve 31, for example manual. After the shutoff valve 31, the second line joins the downstream portion 15. That is, the downstream portion 15 receives the gas issuing from the first 11 and second 13 lines.

Preferably, the cells 3 are supplied with fuel by pressure swing from the first 4 or the second 5 reserve. The downstream pressure reducer 19 is conformed to expand the gas to a third delivery pressure P3 that is lower than the second delivery pressure P2 (for example about 1 bar).

Owing to the pressure differences between the first P1 and second P2 delivery pressure and the presence of the non-return valve 26, when the fuel pressure in the first reserve 4 is higher than the first delivery pressure P1, the cell 3 is supplied by default from the first reserve 4. This means that the gas at the first delivery pressure P1 flows in priority in the supply line 11, 15. However, when the fuel pressure in the first reserve 4 is lower than the first delivery pressure P1, the gas does not flow downstream from the first pressure reducer 12 allowing for the possibility that the gas issuing from the second reserve can flow into the supply line 13, 15 toward the cells 3.

It can therefore be easily understood that the invention, while having a simple and inexpensive structure, allows better management of the fuel supply of an installation.

The installation is more advantageous in particular than an installation that comprises two reserves combined with a high pressure swing plant to switch the supply from one reserve to the other. The use of a high pressure swing plant of this type, which is particularly costly, can be avoided in the installation according to the invention.

Furthermore, in such a configuration with a high pressure swing plant, it would be necessary to measure the pressure in the two reserves to determine the remaining fuel availability.

According to the invention, a single pressure measurement 10 in the second reserve is necessary (the pressure measurement in the first reserve is unnecessary). This single measurement 10 can be connected to an intelligent data remote transmission system 7, 17 to monitor the remaining life of the installation. This serves to reliably and inexpensively determine the moment when the first reserve 4 is empty and must be replaced by a full reserve. The installation according to the invention also serves to indicate any consumption irregularity (particularly leakage). In fact, as soon as the second reserve 5 supplies the cell (indicated by data from the pressure sensor 10 of the second reserve), this means that the first reserve 4 “is insufficient”.

The invention can be applied to any other type of power consuming installation.

1-16. (canceled)

17. A functional installation consuming electric power, comprising:
a fuel cell connected to an electric power consuming member to supply said member with electric power, said fuel cell being of the gaseous fuel type;
a first reserve of gaseous fuel stored under pressure and connected to said fuel cell via a first supply line for supplying said cell by default, said first supply line including a first element adapted to control a pressure of the gaseous fuel and/or expand the gaseous fuel to a first delivery pressure;
a second reserve of gaseous fuel stored under pressure and connected to said fuel cell via a second supply line for supplying said cell, said second supply line including a second element adapted to control a pressure of the gaseous fuel and/or expand the gaseous fuel to a second delivery pressure; and
a gaseous fuel distribution element adapted to detect a fault or insufficiency in supply of the gaseous fuel from said first reserve and automatically switch supply of gaseous fuel to said fuel cell from said first reserve to said second reserve when the insufficiency or fault is detected, wherein the first delivery pressure is different than the second delivery pressure.

18. The installation as claimed in claim 17, characterized in that said fuel cell is supplied by pressure swing.

19. The installation of claim 17, characterized in that said first supply line comprises a nonreturn element preventing passage of the gaseous fuel from said second reserve to said first reserve.

20. The installation of claim 19, characterized in that said first and second supply lines comprise different upstream portions connected respectively to said first and second reserves and meeting at a common downstream portion connected to said cell.

21. The installation of claim 20, characterized in that said common downstream portion comprises a third elemented adapted to control a pressure of the gaseous fuel and/or expand the gaseous fuel to a third delivery pressure.

22. The installation of claim 17, further comprising a container wherein said distribution element, fuel cell and second reserve are disposed within said container.

23. The installation of claim 22, characterized in that the first reserve is not disposed within said container.

24. The installation of claim 17, further comprising:
an element adapted to measure or estimate in real time a quantity of the gaseous fuel that is consumed by said cell;
a data processor connected to said distribution element and being adapted to:
calculate a moment when a predetermined insufficient quantity of gaseous fuel remains in said first reserve based upon a known initial amount of gaseous fuel in said first reserve and the measured or estimated quantity of gaseous fuel consumed; and
control the switching of the gaseous fuel distribution from said first reserve to said second reserve when the moment arrives that the predetermined insufficient quantity of gaseous fuel is reached.

25. The installation of claim 24, characterized in that said data processor is further adapted to store the measured or estimated quantity and transmit the measured or estimated quantity to a system for monitoring a plurality of said installations.

26. The installation of claim 17, further comprising an element adapted to determine and/or acquire an initial quantity of the gaseous fuel in said first reserve.

27. The installation of claim 17, further comprising an element adapted to detect a flow and/or pressure of the gaseous fuel at an outlet of said second reserve.

28. The installation of claim 17, wherein the gaseous fuel is hydrogen.

29. A method for supplying electric power to a functional installation consuming electric power comprising an electric power consuming member, a fuel cell connected to the consuming member to supply the consuming member with electric power, the fuel cell being of the type using a gaseous fuel, and first and second reserves of gaseous fuel suitable for supplying the fuel cell, the method comprising the steps of:
supplying the cell with gaseous fuel by default from the first reserve;
detecting or determining an insufficient or faulty supply of gaseous fuel in the first reserve;
switching said supply of gaseous fuel from the first reserve to the second reserve when the insufficient or faulty supply of gaseous fuel in the first reserve is detected or determined, wherein said detection or determination is achieved by measuring a pressure and/or flow of the gaseous fuel in and/or at an outlet of the second reserve.

30. The method of claim 29, further comprising the steps of:
determining an initial quantity of gaseous fuel in the first reserve;
measuring or estimating a quantity of fuel consumed in real time by the cell;
and;
determining when an insufficient fuel threshold is reached in the first reserve according to the determined initial quantity of gaseous fuel and the measured or estimated quantity of gaseous fuel consumed.

31. The method of claim 29, characterized in said step of detecting or determining an insufficient or faulty supply comprises detecting a flow of the gaseous fuel at an outlet of the second reserve.

32. The method of claim 29, wherein the gaseous fuel is hydrogen.
